(19) United States
(12) Patent Application Publication
(10) Pub. No.: US 2009/0116029 A1
(43) Pub. Date: May 7, 2009

(54) WAVELENGTH DIVISION IMAGE MEASURING DEVICE

(76) Inventors: Yasuo Ohtera, Miyagi (JP); Sato Takashi, Miyagi (JP); Kawakami Shojiro, Miyagi (JP)

Correspondence Address: YOUNG & THOMPSON, 209 Madison Street, Suite 500, ALEXANDRIA, VA, 22314, US

(21) Appl. No.: 12/065,730

(22) PCT Filed: Sep. 5, 2006
(86) PCT No.: PCT/JP2006/317576

§ 371 Date: May 14, 2008

(30) Foreign Application Priority Data
Sep. 6, 2005 (JP) 2005-257611

(51) Int. Cl. G01J 3/45; G02B 5/22

(52) U.S. Cl. 356/456; 359/885

(57) ABSTRACT

A wavelength division image measuring device that can divide a wideband incident light from a measurement object into a plurality of wavelengths with high selectivity to thereby measure these images simultaneously and collectively. Micro periodic irregular lattices are formed on a substrate 302. At this time, a plurality of microscopic element areas 101 with different lattice shapes and lattice periods are repeatedly arranged within a plane of the substrate 302. Next, a high refractive index material and a low refractive index material are alternately laid thereon so as to form a multilayer using a bias spatter method to thereby form a wavelength filter 301 with a photonic crystal structure. Thus, an array of the photonic crystal wavelength filters 031 with a sharp selectivity and different wavelength transmission characteristics can be obtained.

### TECHNICAL FIELD

The present invention relates to a wavelength division image measuring device. More particularly, the present invention relates to an array of wavelength filters composed of microscopic element regions having different in-plane periodic shapes, and a measuring device of color distribution information using the same. Moreover, the present invention relates to a wavelength division image measuring device to allow a real-time wavelength division image measurement capable of obtaining a spatial distribution for every narrow-band wavelength component contained in measured light by one-time imaging.

### BACKGROUND ART

Patent Document 1: Japanese Unexamined Patent Publication (Kokai) No. 2004-325902

Patent Document 2: Japanese Unexamined Patent Publication (Kokai) No. 2004-341506

Patent Document 3: Japanese Patent Publication No.

Patent Document 4: Japanese Unexamined Patent Publication (Kokai) No. 2005-26567

A wavelength filter is an element in which the only component of a desired wavelength band is selectively transmitted or reflected out of a wideband light wavelength spectrum, which is emitted from a measurement object. In the field of optical measurement or image engineering, the wavelength filter is a fundamental element used for obtaining a color image in combination with a light receiving element without wavelength dependence in light sensitivity or with small wavelength dependence therein, and for extracting the light intensity distribution of a specific wavelength component from a measurement object emitting light with a wide wavelength width. A wavelength selection filter with an area of several mm square to several cm square and with uniform structure in its area is relatively easy to be produced, and a large number of filters with various characteristics are produced. These have been realized with, for example, a structure in which particular coloring matter is distributed in resin, or a multilayer film structure of uniform transparent or coloring thin films.

Meanwhile, although a so-called array of wavelength filters, in which a large number of microscopic filter elements with different wavelength characteristics are adjacently arranged, has a large number of application fields as described later, only an array with limited characteristics has been realized due to the difficulty in its production. A typical example includes a filter, in which coloring matters of three colors of red, green, and blue, or four colors of cyan, magenta, yellow, and green are blended into an ink or a resist to thereby form them on a substrate like a mosaic pattern with a printing technique. In general, an ink or resist type color filter is difficult to provide with sharp wavelength selection characteristics. Meanwhile, there has been previously realized some methods as a so-called “wavelength division image measuring device” for imaging an intensity distribution for every wavelength in a target object. Alternatively, it can be realized by combining existing optical elements.

One example is the combination of the above mosaic-like color filter and a CCD (charge-coupled device) array, which is mounted on digital still cameras or digital video cameras. However, since it uses the difference in absorption spectra of the coloring matters, a transmitted wavelength width of each color component is generally wide. Thereby, it is difficult to realize very sharp wavelength transmission characteristics.

In addition, another example includes a configuration in which an emitted light from the target object is successively transmitted through a plurality of filters with different transmission wavelengths, and the wavelength components separated into different paths by the filters are detected with different light receiving elements, or are inputted into a common light receiving element in a time-division manner using an optical shutter. This method has problems that an optical system becomes complicated due to requiring a large number of optical elements, precise alignment between the optical elements is needed for matching the separated images of each wavelength with each other, or the like.

A third example includes a method in which a plurality of exchangeable wavelength filters is prepared in front of a common light receiving element to then photograph images successively while exchanging the wavelength filters, and finally a color image is obtained by synthesizing the images of each wavelength. This method has problems that the photographing of high-speed phenomenon is difficult because of requiring considerable time until one synthesized image is obtained, it is inapplicable to measurement susceptible to vibration because of containing movable parts, the device is large-sized, or the like.

As a fourth example, a method of providing wavelength selectivity to the light receiving element itself has also been realized. For example, when an incident light is decomposed into three colors of red, blue, and green, a light receiving element for absorbing light of red wavelength and transmitting light of blue and green wavelengths, a light receiving element for absorbing only light of green wavelength in a complementary manner, and a light receiving element for absorbing only light of blue wavelength are stacked to transmit light therethrough, so that color information in the three wavelength regions is simultaneously obtained. According to this method, there is provided a solution for the problem of misalignment for the image for every wavelength in the second example and the problem of the real time nature in the third example. Meanwhile, it contains a serious problem that the degree of flexibility in designing wavelength characteristics is restricted due to the material constant of the light receiving element, for example, when the material system and principle of the light receiving element are changed, such as an infrared ray, the fundamental search of material process is needed to realize the filter characteristics, or the like. This is caused by the fact that it is impossible to independently design the wavelength filter and the light receiving element.

Meanwhile, the paragraph number [0072] of Patent Document 1, the paragraph number [0086] of Patent Document 2, or FIG. 1 discloses to use a photonic crystal as the filter, wherein the photonic crystal has a multilayer-structure in which two or more transparent materials are alternately laid in a z direction on a substrate parallel to an xy plane, and which is divided into element regions with different lattice constants in the xy plane. Moreover, it is also described that this filter is used to constitute an array type wavelength division multiplexer. However, it is not described to divide a wideband incident light from a measurement object into a plurality of wavelengths with high selectivity to then measure these images simultaneously and collectively. Furthermore, it is not possible to obtain the spatial distribution for every narrow-band wavelength component contained in measurement light by one-time imaging.

Moreover, Patent Document 4 describes a method of implementing both functions of spectrum separation and light focusing by means of stacking self-cloning type circular periodic multilayer films on the semiconductor layer of a CCD image sensor using it as a base. However, since it is required that the CCD layer of the foundation not to be damaged by forming the multilayer film in this method, limitation on conditions of sputtering and etching for the self-cloning method is imposed thereon, resulting in a problem that a realizable periodic structure is restricted. Additionally, since the effective refractive-index distribution perceived by each linear polarized wave component of the incident light does not become the same concentric-circle shape as the periodic structure in the concentric-circle periodic structure as shown in this document, the shape of light reached to the photoelectric converter of the CCD does not become a circle beam spot. Moreover, since the dispersion relation of light changes according to a location in a pixel, the wavelength component of the light in the same pixel will be transmitted in some location and will not be transmitted in other location. As described above, there is a problem that distinct spectrum separation is difficult in the method described in this document.

### DISCLOSURE OF THE INVENTION

### Problem to be Solved by the Invention

It is an object of the present invention to solve following problems that the above conventional wavelength division imaging device has had, namely, to narrow the band of a selected wavelength is difficult; to simultaneously obtaining the images of each wavelength is difficult; alignment of the image for every wavelength is complicated; equipment becomes large-scaled and alignment between optical elements becomes complicated by use of a large number of optical elements; design concept of the filter needs to be significantly modified when the detector is changed for ultraviolet, visible, or infrared ray; design of a filter for spectral separation is restricted by the configuration of the photoelectric converter; spectral selectivity in the pixel is low; and the like.

It is an object of the present invention to provide a wavelength division image measuring device, which can divide a wideband incident light from a measurement object into a plurality of wavelengths with high selectivity to thereby measure these images simultaneously and collectively. It is an object of the present invention to provide a wavelength division image measuring device, which allows the spatial distribution for every narrow-band wavelength component contained in measurement light to be obtained by one-time imaging.

### Means for Solving the Problem

A wavelength division image measuring device according to the present invention is characterized by combining a wavelength filter array with an edge filter structure and a light receiving element array, wherein the wavelength filter array has a multilayer-structure in which two or more transparent materials are alternately laid in a z direction on a substrate parallel to an xy plane in a three-dimensional orthogonal coordinate system (x, y, z), at least three lattice constants being divided into different element regions in the xy plane, the wavelength filter array has a periodic concavo-convex shape periodically repeated in the xy plane determined for every region in those element regions, and the wavelength filter array has specific wavelength transmission characteristics determined by the concavo-convex shape of each region and a refractive-index distribution of the multilayer film to incident light from a direction which is not parallel to the substrate, wherein the light receiving element array has a pixel arranged opposed to the individual element region constituting the array. Namely, in order to solve the aforementioned problems, the present invention uses a photonic crystal type wavelength filter array characterized in that refractive-index distribution is periodically changed in an in-plane direction and in a thickness direction. Moreover, in order to obtain the images for a plurality of wavelengths simultaneously and collectively, the wavelength division image measuring device is composed by combining the aforementioned filter array and light receiving element array.

### Effect of the Invention

The wavelength selection filter according to the configuration of the present invention allows a measurement target light to be divided into a plurality of wavelength components with very sharp selectivity. Integration of the wavelength filter array composed of this configuration with the light receiving element array, such as CCD, makes it possible to obtain the spatial distribution for every narrow-band wavelength component contained in the measurement light by one-time imaging, which has been difficult to achieve by the conventional technology. An increase in kinds of filter elements to be arrayed allows an increase in the number of wavelengths to be divided as well. Additionally, since only the wavelength filter array and the light receiving element array are used, integration is easily achieved, resulting in small-sizing. Further, even when the wavelength band itself to be the measurement target is greatly changed, design and production of the filter array can be realized according to common guidelines and processes. The wavelength division image measuring device using such a wavelength filter array has wide industrial applications, and can offer image measurement functions, which are not provided by the conventional color image sensors.

### BRIEF DESCRIPTION OF THE DRAWINGS

FIG. 1 is a conceptual diagram showing a top view of a wavelength filter array according to the present invention;

FIG. 2 is a concept diagram showing a formation of a photonic crystal by a self-cloning method;

FIG. 3 is a conceptual diagram of an image measuring device produced by combining the wavelength filter array and a light receiving element array according to the present invention;

FIG. 4 is a conceptual diagram of a short wavelength rejection filter array of a first embodiment;

FIG. 5 is a diagram showing a film thickness configuration of a multilayer film in the first embodiment;

FIG. 6 is a diagram showing transmission characteristics of each element region of the filter array in the first embodiment;

FIG. 7 is a diagram showing an example of a spectral distribution of incident light into the filter array of the first embodiment;

FIG. 8 is a diagram showing a spectral distribution after the light in FIG. 7 passes through each element region of the filter array of the first embodiment;

FIG. 9 is a conceptual diagram of a narrow-band wavelength selection filter array of a second embodiment;

FIG. 10 is a diagram showing transmission characteristics of each element region of the filter array in the second embodiment;

FIG. 11 is a conceptual diagram showing a combination of a wavelength filter array and a uniform wavelength filter in a third embodiment;

FIG. 12 is a diagram showing an example of transmission characteristics of the uniform wavelength filter in the third embodiment;

FIG. 13 is a diagram showing transmission characteristics of one element region in the third embodiment;

FIG. 14 is a conceptual diagram of a polarized wave-dependent wavelength filter array of a fourth embodiment;

FIG. 15 is a diagram showing transmission characteristics of each element region of the filter array in the fourth embodiment;

FIG. 16 is a conceptual diagram showing a combination of a polarized wave-dependent wavelength filter array and a uniform polarizing plate of a fifth embodiment;

FIG. 17 is a conceptual diagram showing a combination of a wavelength filter array and a light receiving element array of a sixth embodiment;

FIG. 18 is a conceptual diagram showing a reconstruction of an image for every wavelength in the sixth embodiment;

FIG. 19 is a diagram showing an example of a method of arranging element regions of the wavelength filter in the sixth embodiment;

FIG. 20 is a diagram showing an example of a method of arranging the element regions of the wavelength filter in the sixth embodiment;

FIG. 21 is a diagram showing a relation between an element region of a wavelength filter and a pixel of a light receiving element in a seventh embodiment;

FIG. 22 is a diagram showing the relation between the element region of the wavelength filter and the pixel of the light receiving element in the seventh embodiment;

FIG. 23 is a conceptual diagram showing a configuration of a filter array for infrared wavelength of an eighth embodiment; and

FIG. 24 is a diagram showing transmission characteristics of each element region of the filter array in the eighth embodiment.

### EXPLANATIONS OF LETTERS OR NUMERALS

101: element region of photonic crystal constituting wavelength filter array

201: substrate

202: vacuum chamber

203: dielectric material target

204: dielectric material target

205: high frequency power supply

206: plasma

207: high frequency power supply for bias

301: wavelength filter array

302: light receiving element array

303: pixels of light receiving element

401: quartz substrate

402: one of element regions of wavelength filter array

403: one of element regions of wavelength filter array

404: one of element regions of wavelength filter array

405: one of element regions of wavelength filter array

406: substrate shaping layer

407: tantalum pentoxide layer

408: quartz layer

901: one of element regions of wavelength filter array

902: one of element regions of wavelength filter array

903: one of element regions of wavelength filter array

904: one of element regions of wavelength filter array

905: quartz substrate

906: tantalum pentoxide layer

907: quartz layer

908: cavity layer composed of tantalum pentoxide

909: substrate shaping layer

1101: wavelength filter array

1102: uniform wavelength filter

1401: one of element regions of wavelength filter array

1402: one of element regions of wavelength filter array

1403: one of element regions of wavelength filter array

1404: one of element regions of wavelength filter array

1405: quartz substrate

1406: tantalum pentoxide layer

1407: quartz layer

1408: cavity layer composed of tantalum pentoxide

1409: substrate shaping layer

1601: wavelength filter array

1602: uniform polarizing plate @@1701: wavelength filter array

1701: wavelength filter array

1702: light receiving element array

1901: element region group, which is repeating unit of wavelength filter array

2001: element region corresponding to one wavelength

2002: element region corresponding to one wavelength

2101: element region

2102: pixels of light receiving element

2103: wavelength filter array

2104: light receiving element array

2201: wavelength filter array

2202: light receiving element array

2203: object lens

2204: imaging lens

2301: one of element regions of wavelength filter array

2302: one of element regions of wavelength filter array

2303: one of element regions of wavelength filter array

2304: one of element regions of wavelength filter array

2305: quartz substrate

2306: lower distributed reflector

2307: cavity layer composed of germanium

2308: upper distributed reflector

### BEST MODE(S) FOR CARRYING OUT THE INVENTION

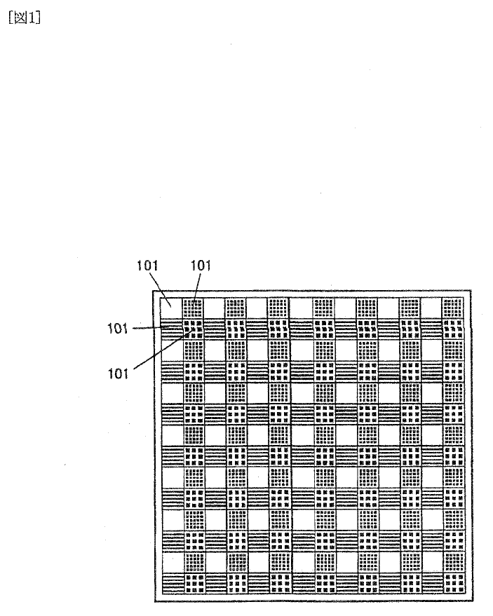

FIG. 1 is a conceptual diagram showing an upper surface of a wavelength filter array according to the present invention. The whole array is composed of a set of element areas 101 of a microscopic photonic crystal. The transmission characteristics to the wavelength are uniform or almost uniform within each element region 101. While this wavelength filter array and a light receiving element array, such as CCD or the like are combined to thereby constitute a wavelength division image measuring device as described later, since a pixel size of the light receiving element array is generally several micrometers square to about 10 micrometers square, a size of the element region 101 is set to an order of the above size in order to match the element region 101 on the filter with the pixel of the light receiving element.

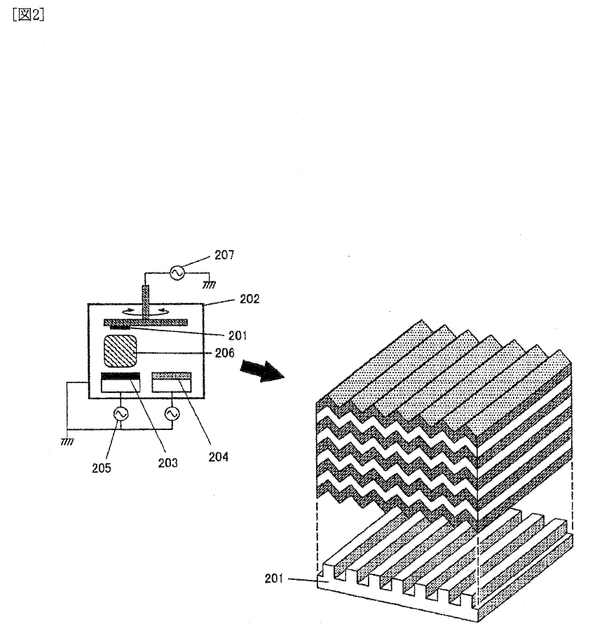

Meanwhile, in order to provide sharp wavelength selection characteristics, the wavelength filter of the photonic crystal is composed of a multilayer film structure. In order to accurately arrange a large number of multilayer film structures with different wavelength characteristics at a spacing of several micrometers to about several tens of micrometers like this, the photonic crystal structure based on a self-cloning method (“A three-dimensional periodic structure and a method of producing the same, and a method of manufacturing a film” Kawakami et al., Japanese Patent Publication No. 3325825) is used. A method of manufacturing the filter array based on this method will be explained using FIG. 2. A mask pattern of a one-dimensional or two-dimensional periodic lattice-shape is formed on a substrate 201 by photolithography, and the mask pattern is subsequently transferred to the substrate using reactive ion etching. Namely, the one-dimensional pattern includes a periodic groove array, and the two-dimensional pattern includes, for example, a periodic array of circle holes or rectangular holes arranged in two directions within a substrate surface.

FIG. 2 shows an example of the one-dimensional pattern. Subsequently, two or more dielectric materials are alternately laid on the substrate, which has been subjected to such a lattice processing using a sputter deposition process that partially includes sputter etching. As an example, a plurality of dielectric material targets 203 and 204 are placed in a vacuum chamber 202, and the substrate is arranged above them. A high frequency power 205 is applied to generate plasma 206 of argon gas or the like in the chamber, and a high frequency power 207 for bias is also applied to the substrate to perform the sputter etching. The power is alternately applied to the targets 203 and 204, and a location of the substrates is moved back and forth above respective targets in synchronization with it, so that the aforementioned alternate multilayer films can be formed. For example, when the narrow-band wavelength selection characteristics are given as wavelength filter characteristics, a lower distributed reflector layer as a first layer, a cavity layer as a second layer, and an upper distributed reflector layer as a third layer may be laid in this order. If a balance between the sputter etching and the sputter deposition is suitably adjusted, the concavo-convex shape in the plane will be kept up to the final layer. The region on the one-dimensional pattern is formed into the two-dimensional photonic crystal, and the region on the two-dimensional pattern is formed into the three-dimensional photonic crystal. The wavelength characteristics of the wavelength filter formed in this way depend on the lattice shape in a horizontal plane as well as the refractive-index distribution of the multilayer film in a thickness direction. Hence, when the lattice shape is changed for every element region in an early substrate processing stage, the array of the microscopic wavelength filters with different characteristics will be formed. The typical configuration of such a photonic crystal of “lattice modulation” type and its production method are disclosed in, for example, “A lattice modulated photonic crystal”, Kawakami et al., Japanese Patent Publication No. 3766844. Particularly, there is used an array in the present invention, in which a modulation state of the lattice, namely, an area of the crystal element and an array method thereof, the number of repetitions of the element itself, or the like is designed for the purpose of aiming at synchronizing with the pixel of the light receiving element array to be a pair. Using electron beam lithography in the early substrate processing makes it possible to accurately set all of these shapes in the plane.

The filter which has been previously demonstrated as the above “lattice modulated photonic crystal” type wavelength selection filter is a filter in which an area of one wavelength filter is equal to or larger than a diameter of an optical fiber, namely, 100 micrometers to several mm on a side, as described in Patent Document 2. When the lattice constant of the photonic crystal of 100 micrometers on a side is 500 nm, two hundreds of lattices are contained in one side, so that the filter will be served as the photonic crystal with a nearly infinite period for an incident light. Thus, a transmission spectrum calculated in an ideal crystal structure with an infinite period could be used as it is as a design value of the filter. Meanwhile, the wavelength filter array according to the present invention is characterized in that the size of each element filter is nearly equal to a pixel pitch of an image sensor. For example, since the pixel pitch of a typical CCD image sensor is in the order of 5 micrometers, about ten photonic crystals with the lattice constant of 500 nm are contained therein per one side, but the constitutional feature of the spectral filter of the present invention is to utilize optical properties of the original infinite period structure which is taken over by such a periodic structure with less period.

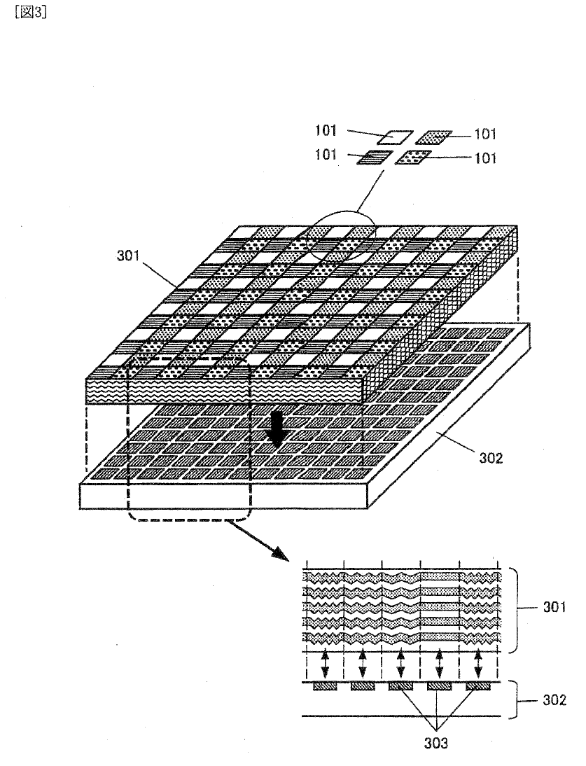

Next, an array wavelength filter 301 and a light receiving element array 302 are combined to constitute the image measuring device in a manner shown in FIG. 3. By matching the sizes and a relative position between the element region constituting the wavelength filter and pixels 303 of the light receiving element, only predetermined wavelength component reaches respective pixels of the light receiving element. By collecting only information on a pixel group corresponding to the element regions with the same wavelength characteristics after measuring light intensity of all the pixels collectively, the image in the wavelength can be reconstructed. While the images of the remaining pixel groups can be reconstructed in a manner similar to the above, the images of respective pixel groups will represent images for each wavelength at the same time since the light intensity distribution of all the pixels is simultaneously photographed originally. Moreover, since an amount of displacement in the plane between the pixel groups for every wavelength is an integral multiple of pixel spacing, it can be accurately grasped. Needless to say, this amount of displacement is not changed after manufacturing the device. Furthermore, very sharp wavelength selection characteristics which are not obtainable in the conventional mosaic type color filter can be easily achieved depending on a design of the refractive-index distribution of the multilayer films constituting the filter. Moreover, the minimum components required for this device includes only one photonic crystal wavelength filter array and one light receiving element array, except for an imaging optical system between a measured object and the wavelength filter array, allowing the measuring device to be significantly downsized.

### First Embodiment

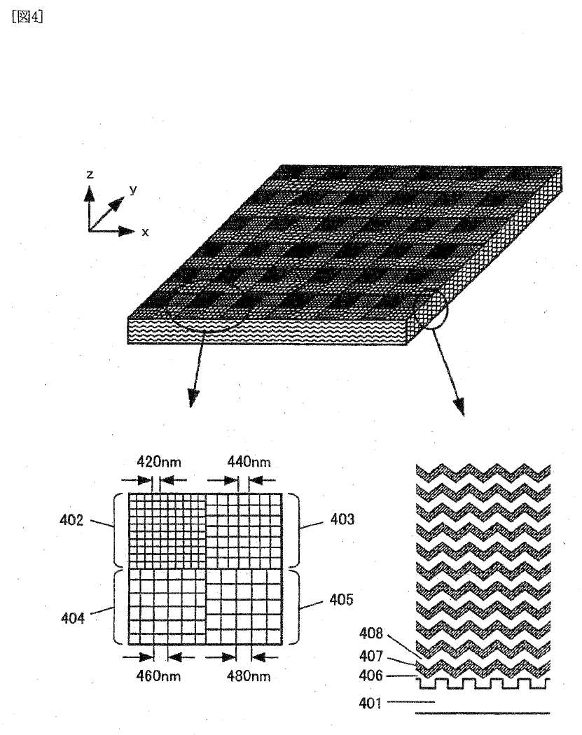

FIG. 4 is a diagram showing one embodiment of the present invention. An embodiment using edge filter characteristics of the photonic crystal in a visible wavelength band is illustrated here. A mask layer composed of 200 nm thick Cr is formed on a quartz substrate 401 by a sputtering method to then apply a photoresist thereon. Four lattice shapes are drawn thereon by a direct lithography using an electron beam. Namely, squares with the lattice spaces of 420 nm in a region 402, 440 nm in a region 403, 460 nm in a region 404, and 480 nm in a region 405 are formed in a square lattice arrangement manner. Areas of respective regions are set to squares of 5 micrometers on a side. Subsequently, the mask of chromium (Cr) is removed by RIE (reactive ion etching) after developing the photoresist to then transfer the pattern to the quartz substrate. An etching depth of the quartz substrate is set at 100 nm.

Subsequently, after forming a transition layer 406 composed of a quartz for connecting a rectangular shape of the substrate with a triangular wave shape which is a unique shape of the self-cloning method, a tantalum pentoxide layer 407 (Ta₂O₅, refractive index of about 2.1) and a quartz layer 408 (SiO₂, refractive index of about 1.5) are alternately laid in this order up to a total of 78 layers by the self-cloning method according to a film thickness profile shown in FIG. 5. The final layer is composed of the quartz. Conditions described in “Loss reduction of photonic crystal waveguide by self-cloning method,” Miura et al., (The Institute of Electronics, Information and Communication Engineers, C, Vol. J88-C, No. 4, 2005) p. 245 are used as the film forming process of the self-cloning method. Note that, even when the transition layer 406 is omitted, there is no difference /ssential to the operation of the element.

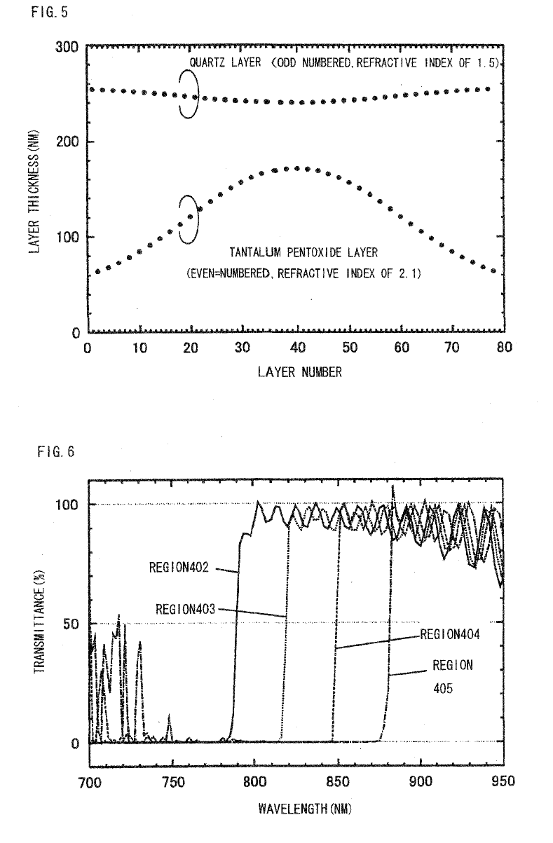

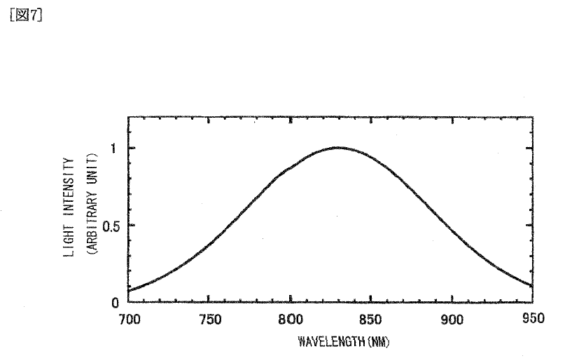

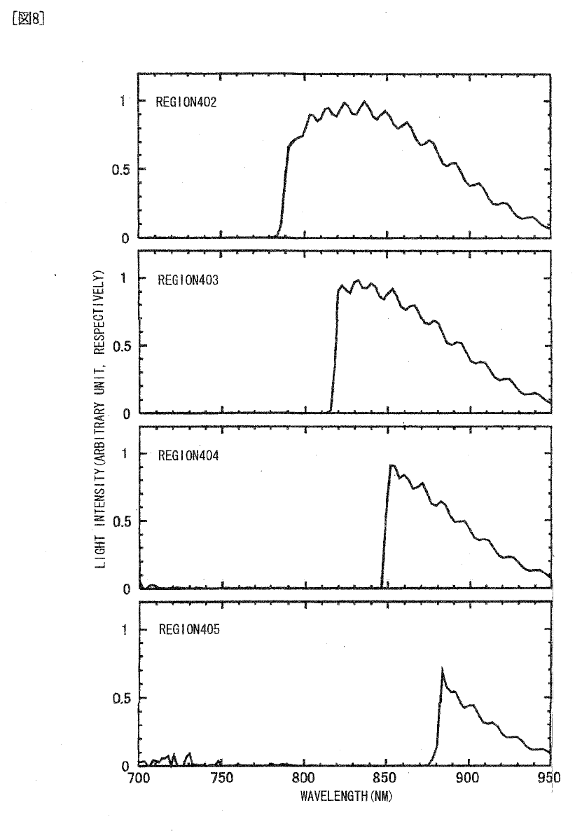

Numerical simulation results of the transmission characteristics of light power in respective regions 402, 403, 404, and 405 to a vertical incident light by a finite differential time domain method (FDTD method) are shown in FIG. 6. It can be seen that respective regions have different wavelength characteristics. In particular, there exists a very sharp wavelength separation bands between 790 nm and 880 nm of the wavelength resulting from a photonic band gap due to the multilayer structure. Here, when a measurement target light having the wavelength spectrum shown in FIG. 7 is entered therein, a spectrum whose shorter wavelength side components are sharply eliminated at different cut-off wavelengths, respectively, is obtained from each region as an output light as shown in FIG. 8. These spectra may be used as they are, or for example, only the spectrum component in a limited bandwidth between 790 nm and 815 nm of wavelength can also be obtained by calculating a difference between the transmitted light intensity of the region 402 and that of the region 403. Incidentally, although the oscillation in transmittance is observed in a long wavelength side of the transmission spectrum of each region in FIG. 6, this is mainly caused by a multiple reflection of the light between the bottom layer and the top layer of the multilayer film. It is also possible to obtain a reflection-free termination by fine adjusting thicknesses of layers near the bottom layer and the top layer. Furthermore, the measurement target light may be entered from the substrate side of the wavelength filter array, and may also be entered from the front side, namely, a side where the photonic crystal is exposed.

Although the quartz is used for the substrate in this example, the material is not limited to the quartz, but various glass, semiconductors, plastics, or the like may be used as far as it is transparent in the wavelength band of measurement target. Additionally, the material and the thickness of the metal mask are not limited to Cr described above either, but other combinations may also be used as far as it is resistant against the transfer processing to the substrate of the lattice shape. Moreover, an operating wavelength band of the wavelength filter composed of the photonic crystal can be designed with a high degree of flexibility based on a selection of the refractive index of the constituent material, film thicknesses, and an in-plane period of the lattice. As a low refractive index medium which can be formed by the self-cloning method, a material which contains SiO₂ as a main component is most commonly used, and it has advantages that the transparent wavelength region is wide, it is stable from chemical, thermal, and mechanical stand point of view, and film forming is easy. However, other optical glasses and other materials of aluminum oxide (Al₂O₃) may be used, and a lower refractive index material such as magnesium fluoride (MgF₂) may be used. As a high refractive index material, oxides and nitrides such as titanium oxide (TiO₂), niobium pentoxide (Nb₂O₅), hafnium oxide (HfO), and silicon nitride (Si₃N₄) can be used for the visible wavelength band other than Ta₂O₅. Meanwhile, in a wavelength band from near-infrared to infrared, semiconductors such as silicon (Si), germanium (Ge), and the like can also be used because they are transparent therein.

### Second Embodiment

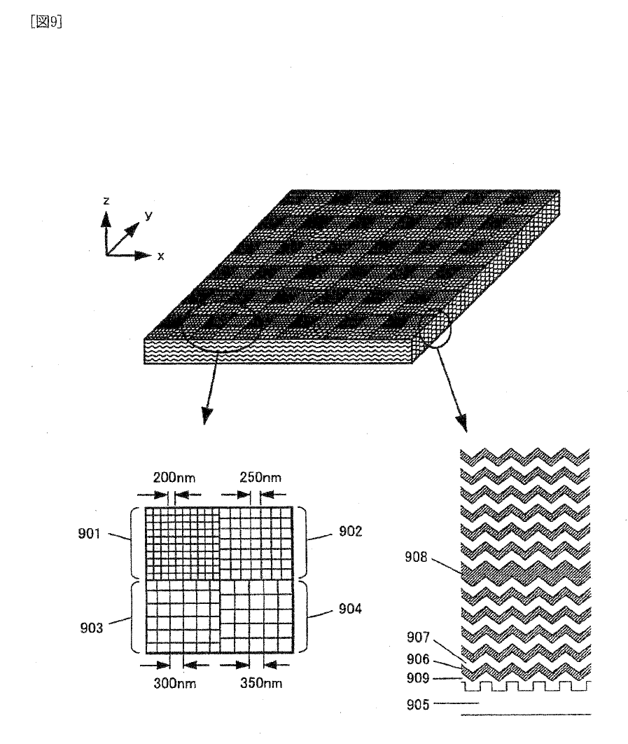

A second embodiment of the present invention is shown in FIG. 9. The present embodiment illustrates a method for using narrow-band wavelength selection characteristics of the photonic crystal. In this embodiment, the lattice shape of a substrate and its production method, and the method of forming a multilayer film by the self-cloning method are the same as those of the first embodiment, but the in-plane lattice period and the film constitution of the multilayer film are different therefrom. Namely, four regions 901, 902, 903, and 904 whose in-plane lattice constants are 200 nm, 250 nm, 300 nm, and 350 nm, respectively, are formed as the element regions of the filter. In the film thickness direction, a Ta₂O₅ layer 906 of 95.2 nm thickness and an SiO₂ layer 907 of 133.3 nm thickness are alternately laid up to a total of 20 layers on a quartz substrate 905, and a Ta₂O₅ layer 908 of 133.3 nm thickness is subsequently laid as a cavity layer. Subsequently, a SiO₂ layer of 133.3 nm thickness and a Ta₂O₅ layer of 95.2 nm thickness are alternately laid up to a total of 20 layers. A substrate shaping layer 909 may be formed as needed in a manner similar to that of the first embodiment. The upper and lower alternate multilayer films which are disposed on both sides of the cavity layer function as distributed reflectors with a high reflectance.

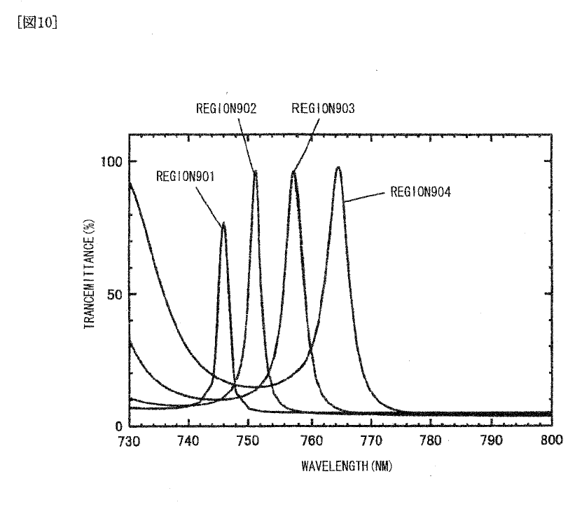

Numerical simulation results of transmission characteristics of light power in respective regions 901, 902, 903, and 904 by the FDTD method are shown in FIG. 10. It is seen that respective regions have transmission peaks of a narrow line-width with a different center wavelengths in a photonic band gap. Here, when the measurement light with the wavelength component from 740 nm to 800 nm of wavelength is entered, only the wavelength components of a narrow range of about 25 nm width having center wavelengths of 746 nm, 751 nm, 758 nm, and 764 nm will be transmitted through the regions 901, 902, 903, and 904, respectively. Thus, the incident spectrum can be divided into fine pieces on a wavelength axis to guide them to the following light receiving elements in this embodiment.

### Third Embodiment

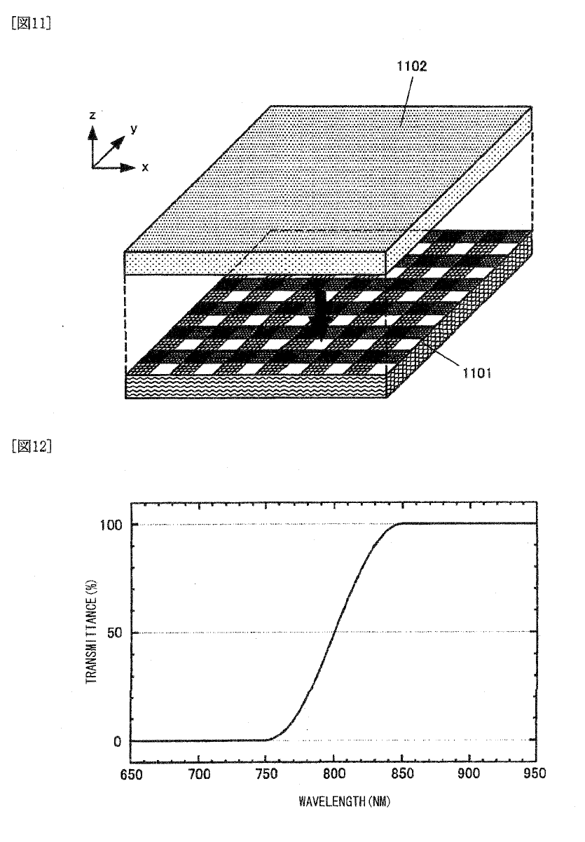

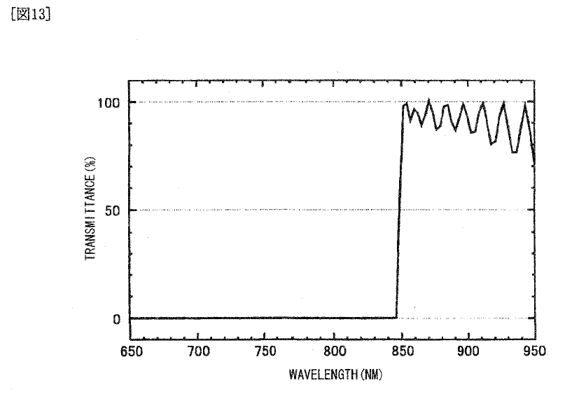

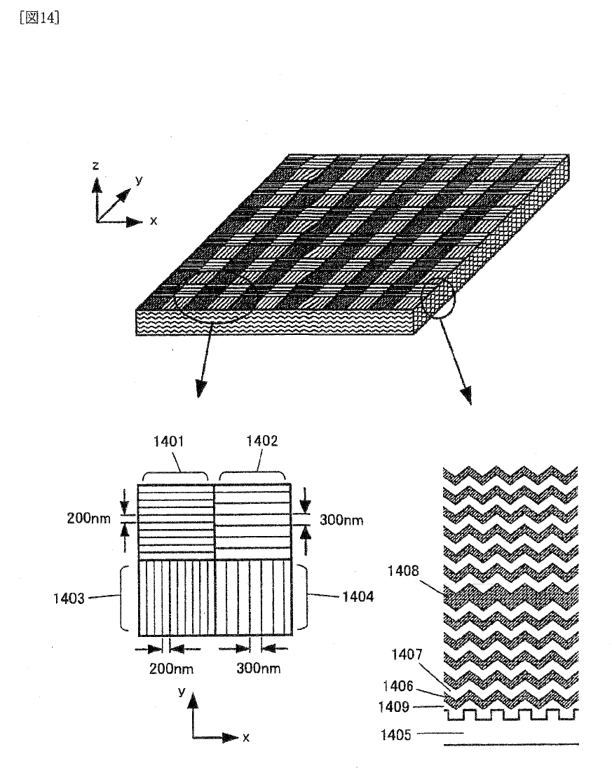

FIG. 11 is a diagram showing a third embodiment of the present invention. Namely, this embodiment is a combination of a filter 1101 in the aforementioned first or second embodiment (this is referred to as a “first filter” only in this embodiment) and a second wavelength filter 1102 which is not arrayed, namely, having uniform wavelength characteristics across a whole incident plane. An example of wavelength characteristics of a second filter is shown in FIG. 12. Since this has a uniform structure across the whole area, special ideas are not required for designing and manufacturing it. When the region 404 of the filter shown in the first embodiment is used as the first filter, combined transmission characteristics of both filters will be shown in FIG. 13. Namely, when the measurement light with the wide wavelength width ranging from 700 nm to 950 nm of wavelength is entered, wavelength components equal to or less than 770 nm of wavelength are also transmitted in the first embodiment, but such an unnecessary wavelength components can be eliminated in a configuration of this embodiment.

### Fourth Embodiment

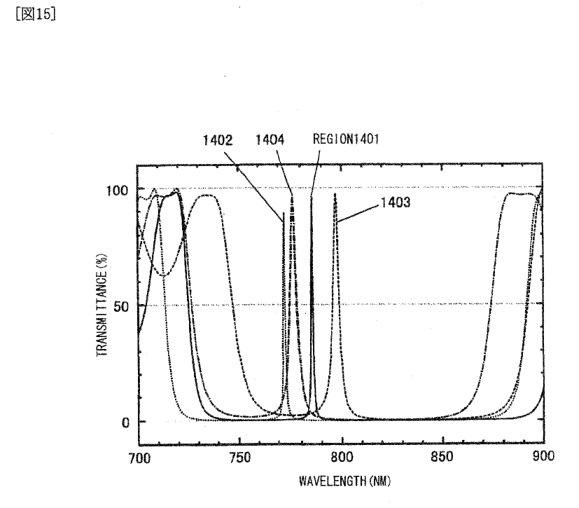

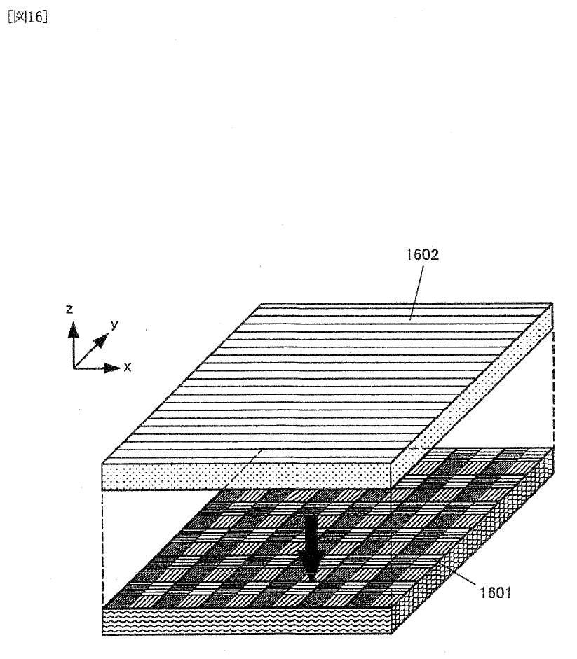

FIG. 14 is a diagram showing a fourth embodiment of the present invention. Each filter region is composed of the two-dimensional photonic crystal, namely, a concavo-convex shape groove array within the plane and alternate multilayer films in the thickness direction. In the two-dimensional photonic crystal, a difference in the wavelength characteristics occurs between a linearly polarized incident light such that an electric field has only a component parallel to the groove (this is referred to as a TE polarized wave) and a linearly polarized incident light such that a magnetic field has only a component parallel to the groove (this is referred to as a TM polarized wave). Hence, when the incident light from the measurement object is polarized in a direction parallel or perpendicular to the groove in advance, the transmitted wavelength of the individual element crystal region will depend on not only the groove space within the plane but also the direction of the groove. FIG. 14 shows a configuration in which the grooves in a region 1401 and a region 1402 are parallel to an x-axis and have the groove spaces of 200 nm and 300 nm, respectively, while the grooves in a region 1403 and a region 1404 are parallel to a y-axis and have the groove spaces of 200 nm and 300 nm, respectively. In the film thickness direction, a Ta₂O₅ layer 1406 of 95.2 nm thickness and an SiO₂ layer 1407 of 133.3 nm thickness are alternately laid up to a total of 20 layers on a quartz substrate 1405, and a Ta₂O₅ layer 1408 of 171.4 nm thickness is subsequently laid as a cavity layer. Subsequently, a SiO₂ layer of 133.3 nm thickness and a Ta₂O₅ layer of 95.2 nm thickness are alternately laid up to a total of 20 layers. A substrate shaping layer 1409 may also be inserted as needed. Calculation results of the transmission spectrum in the vertical incidence to the linearly polarized light, which is polarized in an x direction, are shown in FIG. 15. Respective regions show different transmission characteristics.

### Fifth Embodiment

FIG. 16 is a diagram showing a fifth embodiment of the present invention. Namely, this embodiment has a configuration in which there are combined a filter array 1601 with polarization dependence shown in the fourth embodiment and a polarizing plate 1602 allowing either of the intrinsic polarized waves to be transmitted. The polarizing plate 1602 shall show almost uniform wavelength characteristics and polarized wave characteristics within the plane. As an example of such a polarizer, for example, a photonic crystal polarizer (“Polarizer and production method thereof” Kawakami et al., Japanese Patent Publication No. 3288976) can be used other than the commercially available conventional polarizing plate composed of an organic film. When the light with various polarized wave components is emitted from the measurement object in the above fourth embodiment, the light entered into a certain photonic crystal region will transmit through the filter in the wavelengths of both the transmission wavelength of TE wave and the transmission wavelength of TM wave. Meanwhile, since one of the polarized wave components is eliminated by the uniform polarizing plate in advance in this embodiment, even when the emitted light from the measurement object has an arbitrary polarized wave state, only the wavelength component corresponding to the light having a certain specific polarized wave plane in the emitted light can be selectively extracted.

### Sixth Embodiment

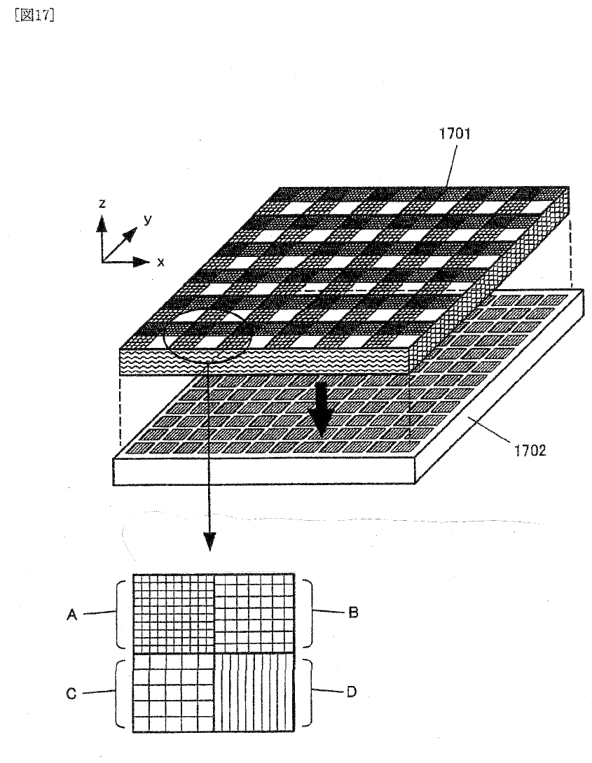

FIG. 17 is a diagram showing a sixth embodiment of the present invention. Namely, this embodiment has a configuration in which a filter array 1701 according to the first embodiment to the fifth embodiment and a light receiving element array 1702 are combined. Here, as the light receiving element array, a CCD (charge-coupled device) image sensor can be used in the visible wavelength band. Incidentally, the light receiving element is not limited to the CCD, but spatial matching between the wavelength filter array and the pixel is essentially important, so that an lnGaAs sensor array, a photodiode array, an image pick-up tube, a vidicon, or the like may be used as far as the matching therebetween is satisfied. Additionally, a MOS type image sensor, such as a CMOS (complementary metal oxide semiconductor) or an NMOS (N-channel metal oxide semiconductor) may be used for applications to measure a phenomenon with relatively less motion. Although an example in which the wavelength filter array is directly located just in front of the light receiving element array is illustrated in this embodiment, the image on the wavelength filter array may be spatially formed on the light receiving element by disposing a relay lens therebetween. It is important to match each element of the wavelength filter array with the light receiving pixel also in this case. Although the wavelength filter array may be placed to face the substrate side to the light incidence side or to the light receiving element side, in order to eliminate a light diffraction effect due to passing through the substrate, the former configuration, namely, the configuration in which the surface of the photonic crystal and the surface of the light receiving element come in touch is more desirable.

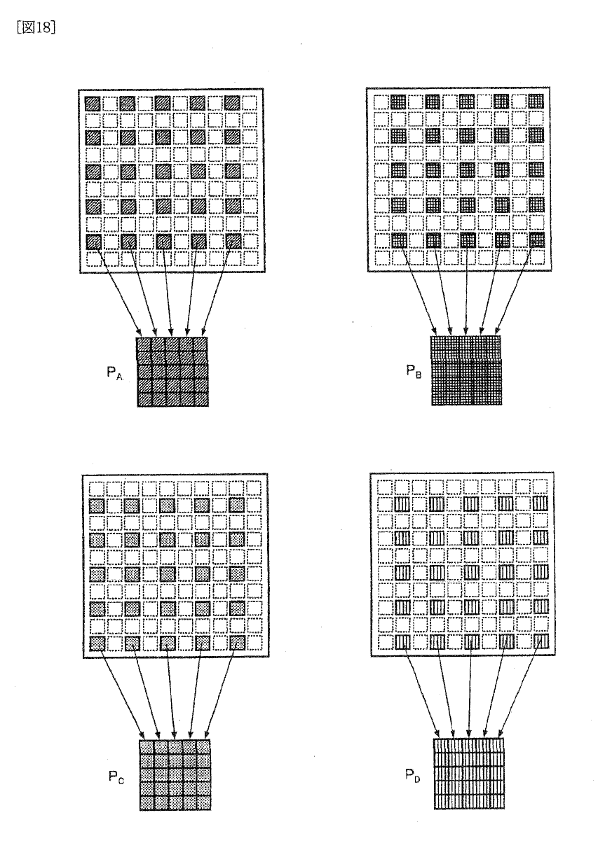

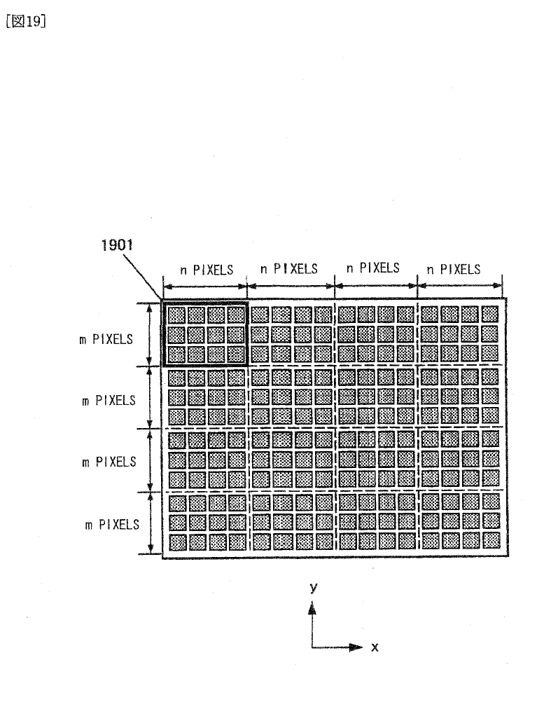

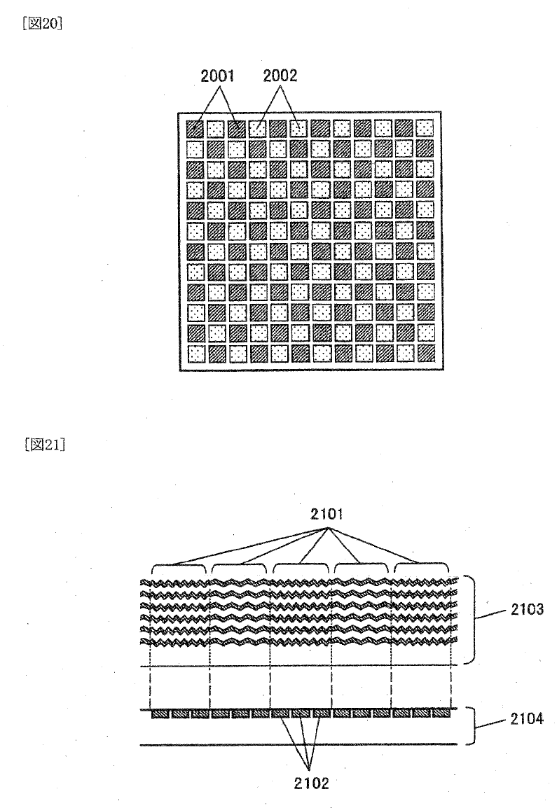

Here, element regions A, B, C and D with different wavelength characteristics in the wavelength filter are considered as one unity, and this unity is repeated at least twice or more in both of the directions of x and y, respectively, as shown in FIG. 17. The transmission center wavelengths in the respective element regions are set to λ_{A}, λ_{B}, λ_{C}, and λ_{D}. The measurement light with wide wavelength is photographed by such an element configuration. Subsequently, pieces of image information from pixel groups P_{A}, P_{B}, P_{C}, and P_{D} corresponding to A, B, C, and D are synthesized as shown in FIG. 18, thus intensity-distribution images of the wavelengths λ_{A}, λ_{B}, λ_{C} and λ_{D} upon photographing can be obtained. Although a total of four element regions, namely, two in the x direction by two in the y direction, are considered as the unity to be arranged in an array shape in this embodiment, a total of (n x m) element regions, namely, n in the x direction by m in the y direction, are considered as a repeating unit 1901 and it may be arrayed as shown in FIG. 19 in general. Although this can increase the kind of wavelengths acquired at one time, the number of pixels per wavelength and a resolution of the image will be reduced when the total number of pixels in the light receiving element is fixed. Moreover, when the number of the kinds of wavelengths to be extracted is two, element regions 2001 and 2002 corresponding to the wavelengths can be arranged in a checkered pattern as shown in FIG. 20. Although the positions of the pixel groups belonging to the same wavelength between the neighboring rows are shifted by one pixel in this case, the whole image can be similarly reconstructed by using the appropriate function interpolation method or the like.

### Seventh Embodiment

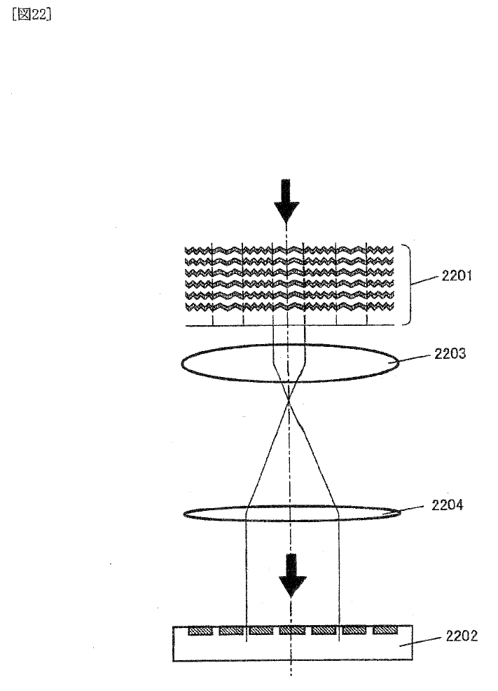

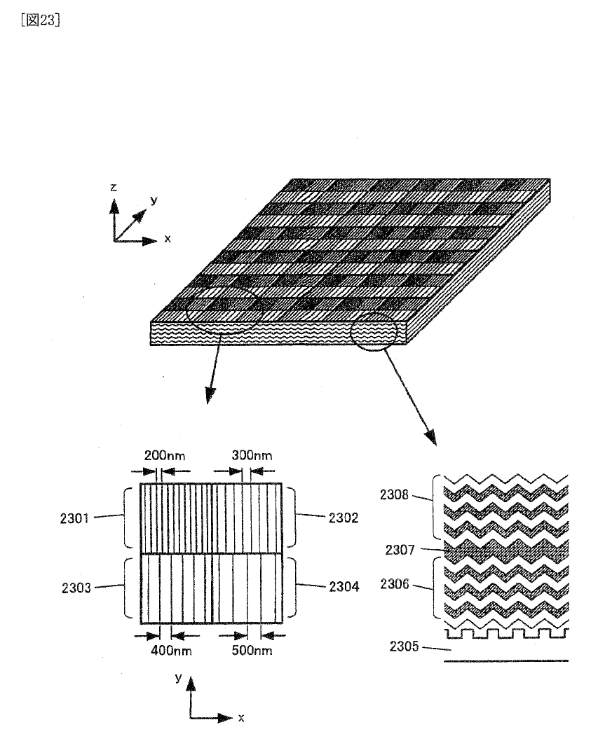

FIG. 21 is a diagram showing a cross-section of a seventh embodiment of the present invention. In this configuration, a plurality of pixels 2102 of the light receiving element correspond to each element region 2101 of the photonic crystal. In this embodiment, there is shown a configuration in which three pixels are contained in one filter element region. As a method for achieving such a configuration, there are a method in which after the size of the filter element region is designed and made so as to actually have the area corresponding to the pixels of (n x n), a filter array 2103 and a light receiving element array 2104 are directly stacked in a manner shown in FIG. 21, and a method in which while keeping the size of the original filter element to the same as that of the pixel, a lateral magnification of an optical system to be inserted between a filter array 2201 and a light receiving element array 2202 is increased by n times as shown in FIG. 22. FIG. 22 shows one example of a configuration of the optical system for increasing magnifications in height and width by three times, respectively. Namely, a ratio of a focal distance of an objective lens 2203 to an imaging lens 2204 is set to 1:3, and the wavelength filter array and the light receiving element array are arranged on a front focal plane of the former and a back focal plane of the latter, respectively. As a matter of course, the optical system for increasing the lateral magnification is not limited to. the example shown here. Meanwhile, an m:1 reduction optical system, in which m element regions of the wavelength filter array correspond to the one pixel, may be employed. In this case, the light transmitted through any of the m element regions will reach the pixel.

### Eighth Embodiment

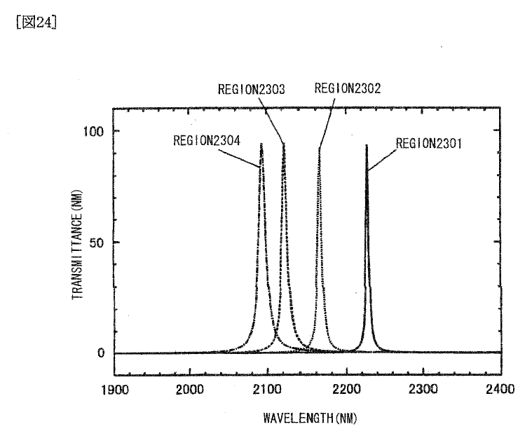

FIG. 23 shows an eighth embodiment of the present invention. This is a configuration example for an infrared band near the wavelength of 2 micrometers. A vidicon, a camera tube, or an InGaAs image sensor is used for the light receiving element. Meanwhile, for the wavelength filter array, there is used a combination of germanium (Ge, refractive index of about 4.1 at the wavelength of 2 micrometers) and SiO₂ (refractive index of about 1.44 at the wavelength of 2 micrometers), wherein they are transparent and a refractive index difference therebetween is large. Element regions 2301, 2302, 2303, and 2304 of the filter have the two-dimensional photonic crystal structure of self-cloning type, in which the groove spaces are 200 nm, 300 nm, 400 nm, and 500 nm, respectively. Additionally, a lower distributed reflector 2306, a cavity layer 2307 composed of 317 nm thick Ge, and an upper distributed reflector layer 2308 are laid on a quartz substrate 2305 within the cross section. Specifically, when a symbol L and a symbol H are used for a 133.3 nm thick SiO₂ layer and a 95.2 nm thick Ge layer, respectively, it results in a film configuration of (quartz substrate)—LHLHL—(germanium cavity)—LHLHL—(air). Calculated values of the transmission characteristics of each element region to an x polarized wave in this configuration are shown in FIG. 24. The design guideline of the filter for infrared wavelength in this embodiment is the numerical calculation of the transmittance of the multi-dimensional photonic crystal based on the theory of the dielectric multilayer film filter, which is the same as that of the visible band, and it is important that the calculation can be carried out based on the concept precisely identical to that of the visible region including calculation software. Even when it is also necessary to use another light receiving element for an ultraviolet wavelength band or a far-infrared wavelength band, dielectric materials, which are transparent in these wavelength bands and is available of the sputter film forming can be selected to independently design the wavelength filter array based on the same guideline.

### INDUSTRIAL AVAILABILITY

The wavelength filter array and the wavelength division imaging device according to the present invention can meet the requirements for measurement functions which have been difficult to be achieved by the conventional device, in a very wide range of fields as listed below.

### 1. Medical Biometric Field

The oxygen saturation of various organizations and its temporal change can be visualized in a two-dimensional manner. Blood containing a large amount of oxygen appears as clear red and otherwise the blood appears to be blue-shifted. This originates in the difference in the absorption spectra between the oxygenated hemoglobin and the reduced hemoglobin contained in blood. The absorbance of red visible wavelength is smaller in the oxygenated hemoglobin. The two-dimensional distribution of oxygen saturation can be obtained by using this difference, photographing the organization for a plurality of wavelengths in the red visible wavelength region near the wavelength of 650-850 nm, and performing operation between the images. Such a two-dimensional distribution of oxygen saturation can be achieved using the narrow band filter array according to the present invention.

### 2. Molecular Biology Field

The indirect measurement for the activation state and its temporal change of a specific protein in a cell is usually performed by visualizing the fluorescence of the protein. In this case, it is needed to separate firstly the wavelength component of excitation light from the image. Moreover, the protein whose center wavelength of fluorescence is gradually different for every kind of protein is identified using the narrow-band wavelength filter. Although a conventional fluorescence microscope has a configuration with a plurality of color filters and thus cannot avoid an increase in the device size, the miniaturization of the device can be achieved by the wavelength division image measuring device of the present invention.

### 3. Astronomical Observation Field

In order to obtain the wavelength division image of a heavenly body, while the wavelength filters are exchanged, the respective images are photographed for long-time exposure, and finally the images are synthesized. There is a problem that the measurement time is shifted between the wavelengths and the measuring device is displaced during the time sift. When the imaging device of the present invention is used, they can be essentially photographed simultaneously.

### 4. Plasma Physics Field

Since the spontaneous emission spectrum by plasma is a group of the line spectra depending on constituent molecules and molecular bonds, the spatial distribution of a molecule of interest can be selectively found by measuring the image in a specific wavelength. Moreover, real-time measurement is also needed to find the temporal change of chemical reaction in the vacuum chamber from immediately after the generation of plasma. The device of the present invention makes these possible.

A large number of applications other than the above examples can be considered. According to the present invention, it is possible to extract simultaneously the image components in a plurality of desired wavelengths from the object image containing a large number of wavelength components. The center wavelength and wavelength bandwidth of the individual component to be selected can be designed with a high degree of flexibility. Moreover, the spatial relationship between the images of the respective wavelengths can also be exactly found, and the displacement does not occur after manufacturing the device. In the application to the wavelength band, such as the ultraviolet or infrared wavelength, which needs to use an image sensor different from that of the visible wavelength, the same guideline as for the visible wavelength can also be used when designing the device.

1-9. (canceled)

10. A wavelength division image measuring device, characterized by combining a wavelength filter array with an edge filter structure and a light receiving element array, wherein the wavelength filter array has a multilayer-structure in which two or more transparent materials are alternately laid in a z direction on a substrate parallel to an xy plane in a three-dimensional orthogonal coordinate system (x, y, z), at least two lattice constants being divided into different element regions in the xy plane, the wavelength filter array has a periodic concavo-convex shape periodically repeated in the xy plane determined for every region in those element regions, and the wavelength filter array has specific wavelength transmission characteristics determined by the concavo-convex shape of each region and a refractive-index distribution of the multilayer film to incident light from a direction which is not parallel to the substrate, wherein the light receiving element array has a pixel arranged opposed to the individual element region constituting the array.

11. The wavelength division image measuring device according to claim 10, wherein only information on a pixel group corresponding to the element region with the same wavelength characteristics is collected after light intensity of all the pixels is measured collectively.

12. The wavelength division image measuring device according to claim 10, wherein two or more element regions whose lattice constants or lattice shapes are different are considered as one repeating unit, and the repeating unit is repeated at least twice or more in an x direction and a y direction.

13. The wavelength division image measuring device according to claim 10, wherein periodic shapes in each element region are differently formed between the x direction and the y direction, so that the wavelength transmission characteristics show polarized wave dependence in a part or all of the element regions constituting the array.

14. The wavelength division image measuring device according to claim 10, wherein an irregular period within the xy plane in the element region constituting the array has a value of 1/10 to 8/10 of an operating wavelength.

15. The wavelength division image measuring device according to claim 10, wherein a multilayer film structure constituting the filter is formed by a sputtering method that partially includes sputter etching.

16. The wavelength division image measuring device according to claim 10, wherein at least two or more element regions with different transmission characteristics are periodically arranged in the array.

17. The wavelength division image measuring device according to claim 10, wherein a plurality of pixels are oppositely arranged corresponding to one element region.

18. The wavelength division image measuring device according to claim 10, wherein the light receiving element array is a photodiode array, a CCD image sensor, a MOS image sensor, an lnGaAs image sensor, an image pick-up tube, or a vidicon.

19. The wavelength division image measuring device according to claim 10, wherein a wavelength range is 790 nm to 880 nm.

20. An image measurement method of collecting only information on pixel groups corresponding to element areas with the same wavelength characteristic after each pixel of the photo detector receives light of only a predetermined wavelength component to then measure the light intensity of all the pixels collectively using the device according to claim 10, to thereby reconstruct the image in the wavelength.

21. The wavelength division image measuring device according to claim 11, wherein two or more element regions whose lattice constants or lattice shapes are different are considered as one repeating unit, and the repeating unit is repeated at least twice or more in an x direction and a y direction.

22. The wavelength division image measuring device according to claim 11, wherein periodic shapes in each element region are differently formed between the x direction and the y direction, so that the wavelength transmission characteristics show polarized wave dependence in a part or all of the element regions constituting the array.

23. The wavelength division image measuring device according to claim 11, wherein an irregular period within the xy plane in the element region constituting the array has a value of 1/10 to 8/10 of an operating wavelength.

24. The wavelength division image measuring device according to claim 11, wherein a multilayer film structure constituting the filter is formed by a sputtering method that partially includes sputter etching.

25. The wavelength division image measuring device according to claim 11, wherein at least two or more element regions with different transmission characteristics are periodically arranged in the array.

26. The wavelength division image measuring device according to claim 11, wherein a plurality of pixels are oppositely arranged corresponding to one element region.

27. The wavelength division image measuring device according to claim 11, wherein the light receiving element array is a photodiode array, a CCD image sensor, a MOS image sensor, an lnGaAs image sensor, an image pick-up tube, or a vidicon.

28. The wavelength division image measuring device according to claim 11, wherein a wavelength range is 790 nm to 880 nm.
